(19) United States
(12) Patent Application Publication
(10) Pub. No.: US 2001/0035509 A1
(43) Pub. Date: Nov. 1, 2001

(54) Method and apparatus for high-speed fluid flow control

(75) Inventors: James Geoffrey Chase, Palo Alto, CA (US); Mark Hosang Yim, Palo Alto, CA (US); Warren Bruce Jackson, San Francisco, CA (US); Rachel King-Ha Lau, San Jose, CA (US); David Kalman Biegelsen, Portola Valley, CA (US)

Correspondence Address: Patent Documentation Center, Xerox Corporation, Xerox Square, 20th Floor, 100 Clinton Ave. S., Rochester, NY, 14644, US

(73) Assignee: Xerox Corporation

(21) Appl. No.: 09/894,492

(22) Filed: Jun. 28, 2001

Related U.S. Application Data
(62) Division of application No. 09/449,040, filed on Nov. 24, 1999.

(51) Int. Cl. F16K 31/02

(52) U.S. Cl. 251/129.01; 251/129.06

(57) ABSTRACT

This invention relates to a method and apparatus for high-speed fluid flow control. More particularly, the invention is directed to a valve formed, at least in part, of an actuating material, such as piezoelectric or anti-ferro-electric material. The valve is used for controlling fluid flow (including air flow) in a variety of devices including imaging devices (e.g. printers, copiers, etc.) for which air flow is used to handle paper. In one embodiment, the subject valve takes advantage of the phenomenon of buckling, resultant bistability and other structural mechanics to efficiently, and in a high-speed manner, open and close to regulate fluid flow. In another embodiment, the valve includes implementation of the actuating material to bend an s-shaped blocking element within the valve. The valve is also advantageously implemented in matrices and formed using batch fabrication techniques.

### BACKGROUND OF THE INVENTION

This invention relates to a method and apparatus for high-speed fluid flow control. More particularly, the invention is directed to a valve formed, at least in part, of an actuating material, such as piezoelectric or anti-ferro-electric material. The valve is used for controlling fluid flow (including air flow) in a variety of devices including imaging devices (e.g. printers, copiers, etc.) for which air flow is used to handle paper. In one embodiment, the subject valve takes advantage of the phenomenon of buckling, resultant bistability and other structural mechanics to efficiently, and in a high-speed manner, open and close to regulate fluid flow. In another embodiment, the valve includes implementation of the actuating material to bend an s-shaped blocking element within the valve. The valve is also advantageously implemented in arrays and formed using batch fabrication techniques.

While the invention is particularly directed to the art of high-speed valves for regulating fluid flow in certain applications such as paper handling, and will be thus described with specific reference thereto, it will be appreciated that the invention may have usefulness in other fields and applications. For example, the invention may be used for controlling concentrations of chemicals over a volume to regulate chemical reactions, liquids, or for controlling sorting processes such as those known in the food processing and drug fields.

By way of background, micro-device valves for use in, for example, paper-handling applications are known. In this regard, U.S. Pat. Nos. 5,839,722; 5,897,097; 5,941,501; and, 5,971,355, all commonly assigned and incorporated herein by this reference, disclose various such valves in an exemplary environment of a microdevice support system for a paper handling system 110. Referring now to FIG. 1, valve and sensor arrays can be used for moving objects, including flexible objects such as papers. As shown, a paper handling system 110 can be optimized for handling sheets of paper 112 without requiring direct physical contact by rollers, belts, or other mechanical transport devices. The paper handling system 110 has a conveyor 120, divided into a lower section 122 and an upper section 124. For clarity, the upper section 124 is cut away to better illustrate paper movement, however, it will be appreciated that the upper section 124 and lower section 122 are substantially coextensive. The sections 122 and 124 are maintained in spaced apart relationship to define a passage 123 therebetween, with the passage sized to accommodate non-contacting passage therethrough of paper 112. Each section 122 and 124 has a plurality of independently or semi-independently controlled adjustable air jets 126 for dynamically supporting, moving, and guiding paper 112 through the system 10. The intensity or directionality of air jets 126 can be controlled by microdevice valves in air jets 126, or even by use of alternative microdevices for directing air flow, such as directional vanes, louvers, or other mechanical air flow redirectors that can be embedded within or adjacent to airjets 126.

The conveyor 120 is constructed from multiple laminate layers with embedded microelectromechanical controllers and sensors. As will be appreciated, using opposed and precisely controllable air jets in sections 122 and 124 having multiple angled orientations is one mechanism for advantageously permitting adjustable application of air flow to opposing sides of paper 112, dynamically holding the paper between sections 122 and 124, while allowing precise control of paper position, velocity, and orientation through application of vertical, lateral, or longitudinal forces (again by directed air jets). As an added advantage, the use of independent or semi-independent controlled adjustable air jets allows for dynamically increasing or decreasing air flow directed against portions of paper 112, allowing straightening, flattening, curling, decurling, or other desired modification in paper topography, as well as adjustments to paper position, orientation and velocity. In addition, paper of various weights, sizes, and mechanical characteristics can be easily supported and accelerated by appropriate modification of the airflow applied by airjets 126. For example, a heavy, thick, and relatively inflexible cardboard type paper may require more air flow from the jets 126 for support and maneuvering, while a lightweight paper sheet may require less overall air flow, but may need quicker and more frequent air flow adjustments directed by the independent or semi-independent air jets 126 to compensate for flutter or edge curling effects. Advantageously, the use of large numbers of independent valve controlled air jets allows diverse paper types and sizes to simultaneously be transported, with appropriate modifications to air flow characteristics being made for each paper in the conveyor 120.

Active flexible object guidance (of paper 112) to correct for flutter and other dynamic problems of flexible objects is enabled by provision of a sensing unit 140 that is connected to the plurality of sensors embedded in the conveyor 120. The sensing unit 140 senses the motion state of paper 112 by integrating information received from the embedded sensors, giving spatial and dynamic information to a motion analysis unit 150 capable of calculating relative or absolute movement of paper 112 from the received sensory information, with movement calculations generally providing overall position orientation, velocity of paper 112, as well as position, orientation, and velocity of subregions of the paper 112 (due to flexure of the paper 112). Typically, the motion analysis unit 150 is a general purpose computer, embedded microprocessor, digital signal processor, or dedicated hardware system capable of high speed image processing calculations necessary for determining object movement. Using this calculated movement information, a motion control unit 152 connected to the motion analysis unit 150 sends control signals to conveyor 120 to appropriately modify movement of paper 112 by selectively increasing or decreasing application of directed air jets to subregions of the paper 112 to reduce flutter, buckling, curling, or other undesired deviations from the desired motion state. As will be appreciated, use of discrete sensors, motion analysis units, and motion control units is not required, with integrated motion analysis and motion control assemblies being contemplated. In fact, it is even possible to provide a plurality of integrated sensors, motion analysis units, and motion control units as integrated microcontroller assemblies on the conveyor, with each air jet being locally or semi-locally controlled in response to locally sensed information.

Whether the sensing unit 140 is discrete or integrated with microcontrollers, in order to ascertain object position properly the sensing unit 140 must be reliable and accurate, ideally having two dimensional spatial and temporal resolution sufficient for overall tracking of the paper through the paper transport path with submillimeter precision, and three dimensional tracking ability for even small areas of the flexible object (typically at less than about one square centimeter, although lesser resolution is of course possible). Further, in many processes the object is moving quickly, allowing less than about 1 to 100 milliseconds for tracking measurements. Fortunately, optical sensors, video imaging systems, infrared or optical edge detectors, or certain other conventional detectors are capable of providing suitable spatial and temporal resolutions. For best results, two-dimensional optical sensors (such as charge coupled devices (CCD's)), or position sensitive detectors are utilized. However, suitably arranged one-dimensional sensor arrays can also be used. As will also be appreciated, sensors other than optical sensors may be used, including but not limited to pressure sensors, thermal sensors, acoustic sensors, or electrostatic sensors.

In operation, use of a sensing unit 140 for feedback control of object movement allows for precise micromanipulation of object motion state. For an illustrative example, in FIG. 1 paper 112 is sequentially illustrated in four distinct positions along conveyor 120, respectively labeled as paper position 108, paper position 114, paper position 116, and paper position 118. In initial position 108, the paper 112 moves along a curving path defined by a flexible portion 130 of the conveyor, constructed at least in part from a flexible laminate. In position 114, the paper 112 becomes slightly misaligned. As paper 112 is moved along conveyor 120 toward position 116 by air jets 126, the embedded sensors provide information that allows sensor unit 140 to calculate a time series of discrete spatial measurements that correspond to the instantaneous position fo paper 112. These elements of a time series of spatial measurement information are continuously passed to the motion analysis unit 150. The motion analysis unit 150 uses the received information (i.e. the sensor measured one, two or three-dimensional spatial information) to accurately determine motion state of paper 112, including its position, velocity, and internal paper dynamics (e.g. trajectory of areas of the paper undergoing curl or flutter). This information (which may be collectively termed “trajectory”) is passed to the motion control unit 152, which computes a new desired trajectory and/or corrective response to minimize deviation from the desired trajectory. The motion control unit 152 sends signals to selected air jets 126 to correct the misalignment, bringing the paper 112 closer to a correct alignment as indicated by position 116. This feedback control process for properly orienting paper 112 by feedback controlled corrections to paper trajectory (the paper 112 now spatially located at position 116) is repeated, with the trajectory of paper 112 finally being correctly aligned as shown at position 118. As will be appreciated, this feedback control process for modifying the trajectory of flexible objects can be quickly repeated, with millisecond cycle times feasible if fast sensor, motion processing, and air jet systems are employed. Faster cycle times are feasible as a function of the processing used, computational load, and particular implementation.

Advantageously, known systems such as this allow for manipulation and control of a wide variety of objects and processes. In addition to paper handling, other rigid solids such as semiconductor wafers, or flexible articles of manufacture, including extruded plastics, metallic foils, wires, fabrics, or even optical fibers can be moved in accurate three-dimensional alignment. As will be appreciated, modifications in layout of conveyor 120 are contemplated, including but not limited to use of curved conveyors (with curvature either in a process direction or perpendicular to the process direction to allow for vertical or horizontal “switchbacks” or turns), use of cylindrical or other non-linear conveyors, or even use of segmented conveyors separated by regions that do not support air jets. In addition, it may be possible to construct the conveyer 120 from flexible materials, from modular components, or as interlocking segmented portions to allow for quick and convenient layout of the conveyor in a desired materials processing path.

The valves used in the above referenced systems disclosed in the prior noted patents, however, are electrostatic valves. Such valves have physical and mechanical characteristics that do not render them entirely conducive to certain applications. For example, electrostatic valves tend to be formed with membranes that are flexible and thin, thus lacking robustness. In addition, electrostatic valves typically lack compatibility with liquid that is regulated in liquid fluid flow systems.

Further, these electrostatic valves do not maintain a physical state or configuration in the absence of power. The valves may be bistable with power applied thereto; however, the devices return to a default state once the power is removed. The significance of this characteristic becomes amplified in circumstances where arrays of valves are formed and individually addressing the valves is desired. If, for example, a 1000×1000 array of valves is fabricated, one million wires would be needed to address and power each valve. This excessive amount of wiring is problematic in many applications.

Bimorph actuators have also been proposed to construct air flow valves. However, these valves are not bistable and are normally closed.

The present invention contemplates a new and improved high-speed valve that overcomes the above-referenced difficulties and others.

### SUMMARY OF THE INVENTION

A method and apparatus for high-speed fluid flow control are provided.

In one aspect of the invention, the apparatus comprises a valve body having a base portion and wall portions, at least one aperture defined in the base portion for ingress or egress of the fluid, an actuating element attached between the wall portions—the actuating element comprising a material having a plurality of physical states that varies as a function of applied voltage and being positioned to transition from a first physical state to a second physical state to selectively open and close the aperture, the transition including a buckling of the actuating element, and electrodes positioned to apply the voltage to the actuating element.

In another aspect of the invention, the actuating element is formed of piezoelectric material.

In another aspect of the invention, the actuating element is formed of one of anti-ferro-electric material and a ferro-electric material.

In another aspect of the invention, the actuating element is formed of ferro-electric material.

In another aspect of the invention, the actuating element is a diaphragm.

In another aspect of the invention, the actuating element comprises multiple layers.

In another aspect of the invention, the multiple layers are selectively actuated by the applied voltage.

In another aspect of the invention, the actuating element maintains the second state in the absence of the applied voltage.

In another aspect of the invention, the apparatus is adaptable to be addressable in a matrix.

In another aspect of the invention, the method of actuation is comprised of steps of applying the voltage to the electrodes to actuate the actuating element while the actuating element is in a first physical state, maintaining the application of the voltage to buckle the actuating element into a second physical state, and removing the application of the voltage such that the actuating element remains in the second physical state.

In another aspect of the invention, the method further comprises selectively applying the voltage to corresponding electrodes of multiple layers of the actuating element.

In another aspect of the invention, the apparatus comprises a valve body having a base portion and wall portions, an aperture defined in the base portion for ingress and egress of the fluid, a blocking element attached between the base portion and a wall portion—the blocking element having at least one actuating element formed thereon, the actuating element comprising a material having a plurality of physical states that varies as a function of applied voltage and being positioned to transition from a first physical state to a second physical state to selectively open and close the aperture, and electrodes positioned to apply the voltage to the actuating element.

In another aspect of the invention, the blocking element has a substantially s-shaped configuration.

In another aspect of the invention, the actuating element is formed of a piezoelectric material In another aspect of the invention, the actuating element is formed of one of an anti-ferro-electric material and a ferro-electric material.

In another aspect of the invention, the at least one actuating element comprises a plurality of actuating elements positioned such that selective actuation of each of the actuating elements generates bending moments in the actuating elements to move the blocking element to vary the configuration.

In another aspect of the invention, the at least one actuating element comprises two actuating elements.

In another aspect of the invention, the method is comprised of steps of selectively actuating a first actuating element by applying the voltage thereto to generate a first bending moment in the actuating element to place the actuating element, and concurrently actuating a second actuating element by applying the voltage thereto to generate a second bending moment in the second actuating element such that the first and second bending moments are of opposite sense to alter the configuration of the blocking element.

In another aspect of the invention, a system comprises a substrate, a plurality of valves positioned on the substrate in a matrix configuration having rows and columns—each valve including a valve body having a base portion and wall portions, an aperture defined in the base portion for ingress and egress of the fluid, an actuating element attached between the wall portions, the actuating element comprising a material having a plurality of physical states that varies as a function of applied voltage and being positioned to transition from a first physical state to a second physical state to selectively open and close the aperture, the transition including a buckling of the actuating element, and electrodes positioned to apply the voltage to the actuating element —a plurality of row address lines, each row address line corresponding to a row of valves, and a plurality of column address lines, each column address line corresponding to a column of valves.

In another aspect of the invention, each actuating element maintains the second state in the absence of the applied voltage.

A primary advantage of the present invention is that it provides a valve that performs at relatively high-speed levels.

Another advantage of the present invention in certain embodiments is that it provides a valve that is bistable, i.e. stable in two configurations, irrespective of whether the valve is supplied with power at all times because of the employment of the principles of buckling.

Other advantages of the present invention include low cost, insensitivity to surface roughness, relative strength, low power consumption, compatibility with liquid fluid flow applications and ease of fabrication.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction. arrangement and combination of the various parts of the device, and steps of the method, whereby the objects contemplated are attained as hereinafter more fully set forth, specifically pointed out in the claims, and illustrated in the accompanying drawings in which:

FIG. 1 is a partial view of a paper handling system having a conveyor with air jets and micro-device sensors;

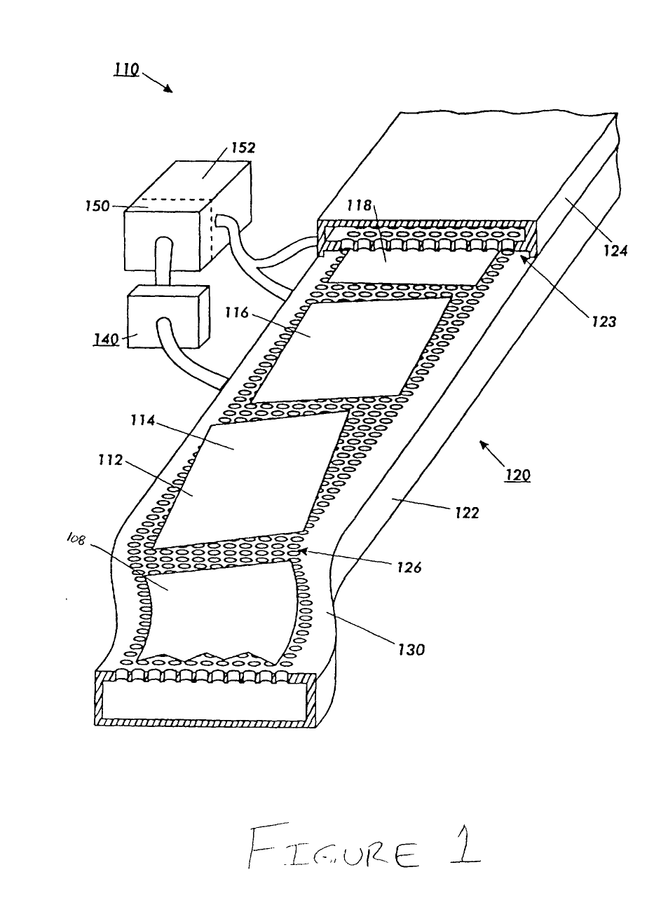

FIGS. 2(a)-(d) are cross sectional views of a valve of a first embodiment according to the present invention;

FIGS. 3(a)-(c) are cross sectional views of a valve of another embodiment according to the present invention;

FIG. 4 is a cross sectional view of a valve of still another embodiment of according to the present invention;

FIG. 5 illustrates a portion of a matrix of valves according to the present invention; and,

FIGS. 6(a)-(b) are cross sectional views of valves according to further embodiments of the present invention.

### DETAILED DESCRIPTION OF THE PREFERRED EMBODIMENTS

The present invention is directed to an improved high-speed valve—advantageously implementing actuating elements formed of, for example, piezoelectric material—for use in the systems described above as well as others. The advantages will become apparent to those skilled in the art upon a reading of the present description. As noted above, such advantages include high-speed performance (10 kHz range and higher), relatively low cost, insensitivity to surface roughness, relative strength when compared to electrostatic valves, low power consumption, bistability (for purposes of being matrix addressable in certain applications), compatibility with liquid fluid applications and ease of fabrication.

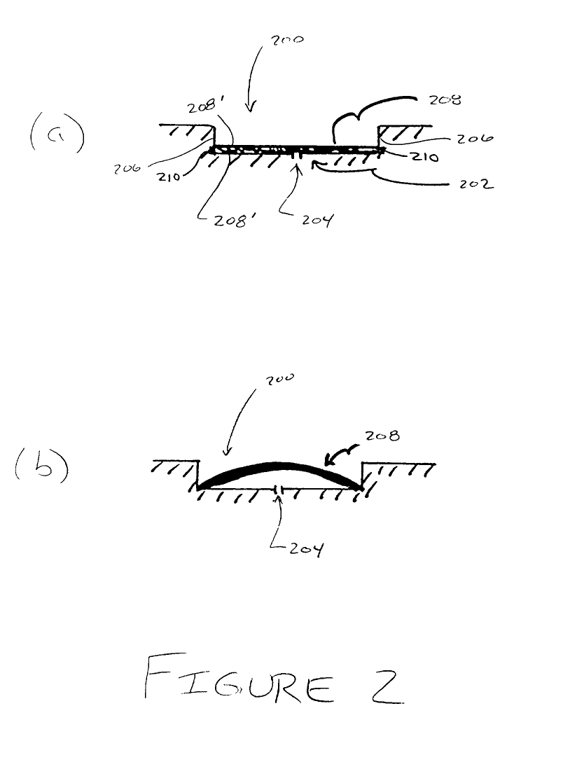

Referring now to the drawings wherein the showings are for purposes of illustrating the preferred embodiments of the invention only and not for purposes of limiting same, FIGS. 2(a)-(d) provide views of a preferred valve according to the present invention. As shown, in FIG. 2(a) and (b), a valve 200 includes a base portion 202 having an aperture 204 defined therein. The valve 200 also includes wall portions 206 that have connected thereto an actuating element 208. It is to be appreciated that the aperture 204 (as well as other apertures disclosed herein) is only representatively shown and preferably is connected to another volume of fluid from which fluid may flow depending on the state of the valve. It is to be appreciated that the actuating element 208 also has electrodes connected thereto that suitably take the form of layers 208′, for example.

FIG. 2(a) shows the valve 200 in a closed position, i.e. where the actuating element 208 is sealed against the aperture 204. Conversely, FIG. 2(b) illustrates the valve in an open position, i.e. where the actuating element 208 is buckled upwardly to allow fluid to flow through the aperture 204. To induce the transition from the configuration shown in FIG. 2(a) to the configuration shown in FIG. 2(b), a voltage is applied to the actuating element 208 to elongate the material against fixed ends shown at 210. Application of the voltage may be accomplished in a variety of manners that are well known to those skilled in the art. Nonetheless, the resulting axial load generated by the application of the voltage results in the buckling of the actuating element.

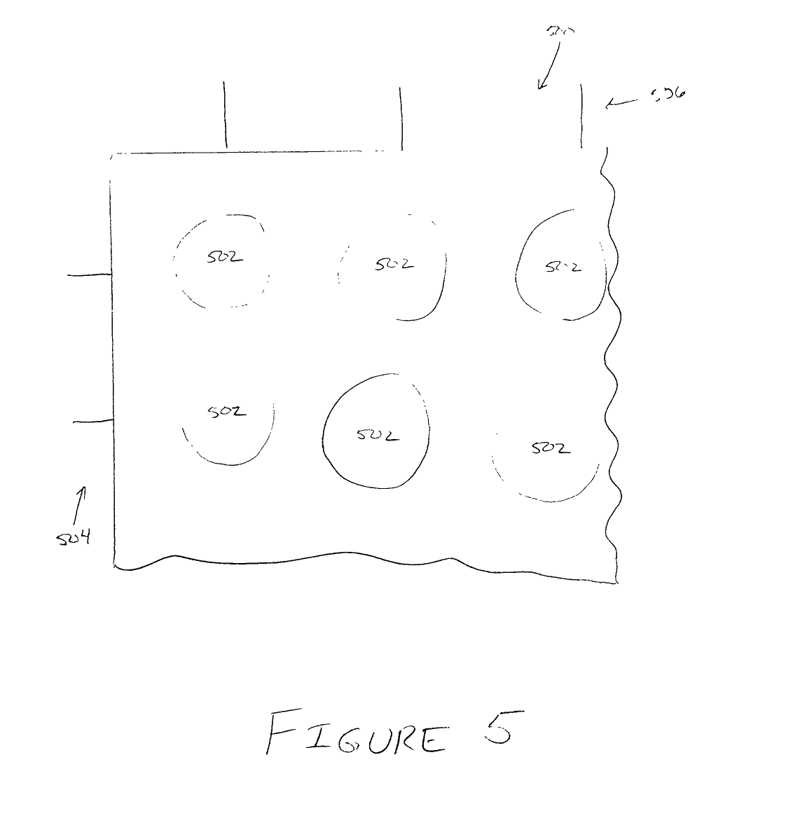

Preferably, the actuating element is formed of piezoceramic (e.g. piezoelectric) material or other material that changes strain state upon the application of a voltage. More specifically, these materials have a plurality of physical states and are consequently capable of changing shape due to an applied voltage and are well known in the art. For example, anti-ferro-electric and ferro-electric materials, similar in nature to piezoelectric material, may also be employed for applications according to the present invention. When structures such as 208 are fabricated using piezoceramic, ferro-electric and anti-ferro-electric materials, once such materials are strained to a given point, i.e., buckled from one physical state to another, they remain in that strained state even if the applied voltage is removed. This feature provides various advantages that will be discussed in detail below in connection with, for example, FIG. 5.

With reference to FIGS. 2(c)-(d), it is to be appreciated that the configurations of the actuating elements implemented to obtain the advantages of the present invention may vary. For example, as shown in FIG. 2(c), the valve 200 includes an actuating element 208 that is a substantially circular diaphragm with vent holes as shown at 212. In FIG. 2(d), the valve 200 includes an actuating element 208 that is flap-like (e.g. substantially rectangular) with notched areas, such as indicated at 214, for purposes of facilitating buckling by locally reducing the stiffness of the actuating element. Of course, it should be recognized that the notched areas are not necessary.

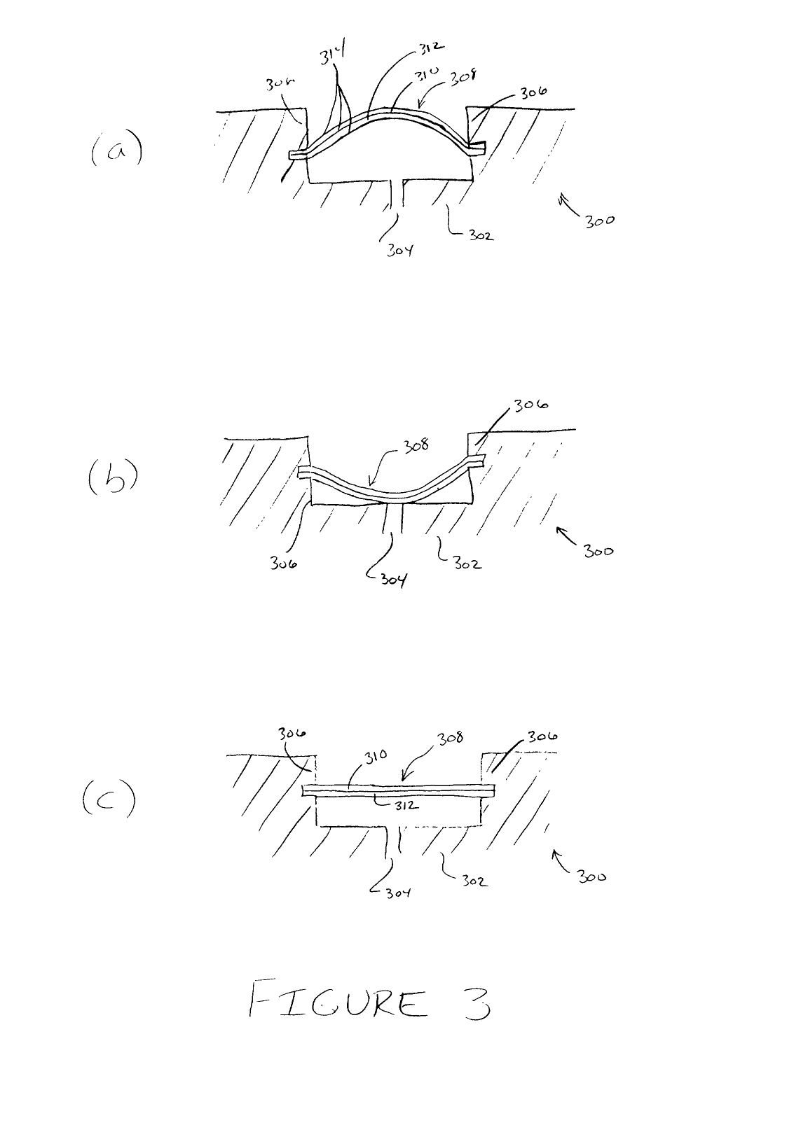

Referring now to FIGS. 3(a)-(c), a valve 300, which may take the general shapes of the configurations illustrated in FIGS. 2(c)-(d) as well as other suitable configurations, is illustrated. The valve 300 includes a base portion 302 having an aperture 304 formed therein. Wall portions 306 have attached therebetween an actuating element 308. In this embodiment the actuating element 308 has multiple layers. As shown, actuating layers 310 and 312 are positioned between electrode layers 314 to effect suitable actuation of the layers. The provision of multiple layers in the embodiment shown in FIGS. 3(a)-(c) allow for the actuating element 308 to be buckled in two directions.

In this regard, FIG. 3(a) illustrates the valve in an open state. FIG. 3(b) illustrates the valve in a closed state. In addition, FIG. 3(c) illustrates the valve 300 in a nominal state, which may also be considered an open state for certain applications.

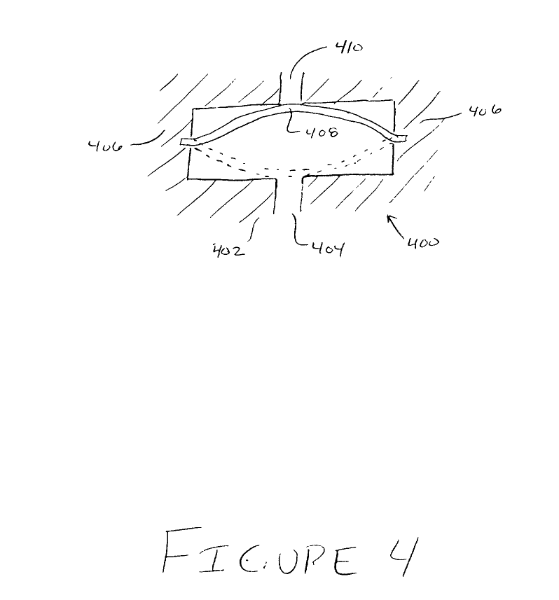

Referring now to FIG. 4, a valve 400 is shown. This valve includes a base portion 402 having an aperture 404 defined therein. The valve 400 also includes wall portions 406 with a multi-layer actuating element 408 connected therein and an additional aperture 410 provided in a top wall portion. The embodiment of FIG. 4 illustrates an advantage of implementation of a multi-layered actuating element described in connection with FIGS. 3(a)-(c). As shown, the actuating element 408 may be buckled in either direction to selectively close the apertures 404 and 410.

The multi-layer actuating elements 308 and 408 are preferably actuated by the application of a unique series of voltage signals through their respective electrodes to selectively transition the actuating elements from a first physical state to a second physical state. The transition preferably is achieved by providing a mechanical buckling of the material. In this regard, with exemplary reference to FIG. 3(c) for convenience (although the following discussion is equally applicable to the valve 400 of FIG. 4), a voltage is provided to the layer 310 to initiate the expansion of the layer to cause movement. Once the actuating element 308 is moving in a direction, the layer 312 is similarly actuated to continue to drive the actuating element in the direction of movement and cause the element to buckle. This configuration is illustrated in FIG. 3(a). Once buckled, the element will remain in that position irrespective of whether power is supplied to the valve.

To unbuckle the actuating element 308, the layer 312 is actuated with a voltage of a polarity opposite to the voltage that moved the element in the direction to place it in the position of FIG. 3(a). Once the actuating element is moving in the direction desired, the layer 310 is actuated with a similarly sensed polarity to return the actuating element to the position of FIG. 3(c). Of course, it is to be appreciated that the actuating element 308 could be transitioned from the configuration of FIG. 3(c) to the configuration of FIG. 3(b) in like manner.

It should be further recognized that the exemplary valve 300 may not require the nominal state shown in FIG. 3(c). In this case, the actuating element 308 will preferably toggle between the positions shown in FIGS. 3(a) and (b). To effect this toggling, similar sequences of voltage signals should be applied as above except that the actuating element will be driven through the nominal position with the application of suitable voltage signals. The conservation of momentum may be applied in these circumstances to toggle the actuating element from the stable position of FIG. 3(a) to the stable position of FIG. 3(b), or vice versa, in a fast and efficient manner. Those skilled in art will further appreciate that the principle of using momentum to drive the actuating element through the nominal position could also be applied to actuating elements of a single layer in appropriate circumstances.

With reference now to FIG. 5, a matrix or array 500 of the valves positioned on a substrate in a matrix configuration having rows and columns is illustrated. This matrix includes valves 502 that are selectively addressable through row address lines 504 and column address lines 506. In this configuration, the array of valves is matrix addressable such that any single valve can be addressed by accessing a suitable row address line and a column address line. The valve can thus be opened and closed independent of the surrounding valves. Moreover, the valve array retains its state even if power is removed.

The primary reason that non-volatile matrix addressability is feasible with the valves of the present invention, but not prior art electrostatic valves, is that the valves take advantage of the principles of buckling. As a consequence, no power is required for any valve to maintain a buckled physical state. Thus, separate lines are not required for each valve. In an array of valves numbering 1000×1000, only 2000 lines are required, not the one million as would be required to individually address a electrostatic array of similar size.

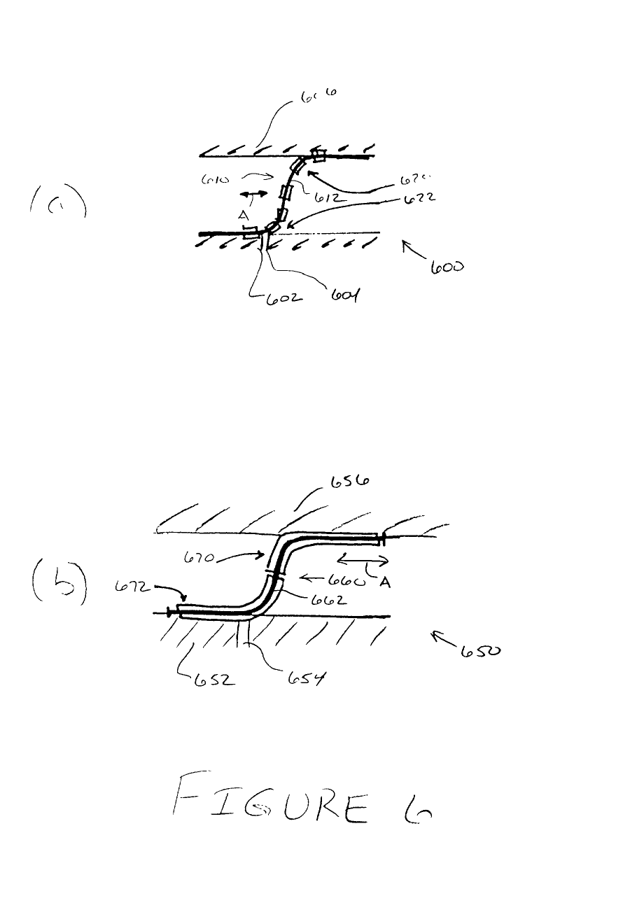

Referring now to FIG. 6(a), an alternative embodiment of the present invention is shown. A valve 600 includes a base portion 602 having an aperture 604 formed therein. A top wall portion 606 is also shown. A blocking element 610 is positioned between the base portion 602 and the top wall portion 606. Significantly, actuating elements such as those shown at 620 and 622 are positioned on a membrane 612. The actuating element positioned on the membrane can be selectively actuated (through suitably positioned electrodes) to bend (or roll) the s-shaped configuration of the membrane to open and close the aperture 604. As shown the s-shape can be moved in the directions indicated by the arrow A. Preferably, the actuating elements on the “corners” of the s-shape are actuated while the other actuating elements are not so actuated.

Referring now to FIG. 6(b), a similar device is shown. In this embodiment, a valve 650 includes a base portion 652 having an aperture 654 defined therein. Also shown is a top wall portion 656. A blocking element 660 includes a membrane 662 having actuating elements 670 and 672 formed thereon. In operation, the actuating elements are actuated to generate bending moments therein to move the s-shaped configuration in the direction of the arrow A as shown to open or close the aperture 654.

It is to be appreciated that the valves of the present invention may be constructed of a variety of materials that will be apparent to those skilled in the art, provided that the actuating elements implemented comprise a material that has a plurality of physical states that vary as a function of an applied voltage and, for selected embodiments, are of a mechanical character to allow buckling. For example, lead zirconate titanate (PZT) is the preferred piezoelectric material. However, polyvinylidene difluoride (PVDF or PVF2), zinc oxide (ZnO) and others can be used. In addition, the base and wall portions of the present valves may be formed of metal, plastic or any other rigid material that is advantageously batch fabricated or injection molded. An elastomer material such as Latex or Viton may also be suitably disposed around the aperture for sealing purposes. Further, the membrane for the S-shaped valve may be formed of any suitable flexible material, including Mylar. Similarly, the valves may be constructed in a variety of manners including batch fabrication. In some circumstances, formation processes that take stress and strain forces into account should be implemented.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

Having thus described the invention, we hereby claim:

1. An apparatus for controlling flow of fluid, the apparatus comprising:
a valve body having a base portion and wall portions;
at least one aperture defined in the base portion for ingress or egress of the fluid;
an actuating element attached between the wall portions, the actuating element comprising a material having a plurality of physical states that varies as a function of applied voltage and being positioned to transition from a first physical state to a second physical state to selectively open and close the aperture, the transition including a buckling of the actuating element; and,
electrodes positioned to apply the voltage to the actuating element.

2. The apparatus as set forth in claim 1 wherein the actuating element is formed of piezoelectric material.

3. The apparatus as set forth in claim 1 wherein the actuating element is formed of one of ferro-electric and anti-ferro-electric material.

4. The apparatus as set forth in claim 1 wherein the actuating element is a diaphragm.

5. The apparatus as set forth in claim 1 wherein the actuating element comprises multiple layers.

6. The apparatus as set forth in claim 5 wherein the multiple layers are selectively actuated by the applied voltage.

7. The apparatus as set forth in claim 1 wherein the actuating element maintains the second state in the absence of the applied voltage.

8. The apparatus as set forth in claim 1 wherein the apparatus is adaptable to be addressable in a matrix.

9. A method for controlling flow of fluid in a system including a valve having a body having a base portion and wall portions, an aperture defined in the base portion for ingress and egress of the fluid, an actuating element attached between the wall portions, the actuating element comprising a material having a plurality of physical states that varies as a function of applied voltage, and electrodes the method comprising steps of:
applying the voltage to the electrodes to actuate the actuating element while the actuating element is in a first physical state;
maintaining the application of the voltage to buckle the actuating element into a second physical state;
removing the application of the voltage such that the actuating element remains in the second physical state.

10. The method as set forth in claim 9, wherein the actuating element comprises multiple layers and corresponding electrodes, further comprising selectively applying the voltage to the corresponding electrodes of the multiple layers.

11. An apparatus for controlling flow of fluid, the apparatus comprising:
a valve body having a base portion and wall portions;
an aperture defined in the base portion for ingress and egress of the fluid;
a blocking element attached between the base portion and a wall portion, the blocking element having at least one actuating element formed thereon, the actuating element comprising a material having a plurality of physical states that varies as a function of applied voltage and being positioned to transition from a first physical state to a second physical state to selectively open and close the aperture; and,
electrodes positioned to apply the voltage to the actuating element.

12. The apparatus as set forth in claim 11 wherein the actuating element is formed of a piezoelectric material.

13. The apparatus as set forth in claim 11 wherein the actuating element is formed of one of an anti-ferro-electric material and a ferro-electric material.

14. The apparatus as set forth in claim 11 wherein the blocking element has a substantially s-shaped configuration.

15. The apparatus as set forth in claim 11 wherein the at least one actuating element comprises a plurality of actuating elements positioned such that selective actuation of each of the actuating elements generates bending moments in the actuating elements to move the blocking element to vary the configuration.

16. The apparatus as set forth in claim 11 wherein the at least one actuating element comprises two actuating elements.

17. A method for controlling flow of fluid in a system including a valve having a body having a base portion and wall portions, an aperture defined in the base portion for ingress and egress of the fluid, a blocking element having a substantially s-shaped configuration and a plurality of actuating elements positioned thereon, the actuating element comprising a material capable of bending as a function of applied voltage, and electrodes positioned on each actuating element, the method comprising steps of:
selectively actuating a first actuating element by applying the voltage thereto to generate a first bending moment in the actuating element to place the actuating element; and,
concurrently actuating a second actuating element by applying the voltage thereto to generate a second bending moment in the second actuating element such that the first and second bending moments are of opposite sense to alter the configuration of the blocking element.

18. A system for controlling flow of fluid, the system comprising:
a substrate;
a plurality of valves positioned on the substrate in a matrix configuration having rows and columns, each valve including
a valve body having a base portion and wall portions,
an aperture defined in the base portion for ingress and egress of the fluid,
an actuating element attached between the wall portions, the actuating element comprising a material having a plurality of physical states that varies as a function of applied voltage and being positioned to transition from a first physical state to a second physical state to selectively open and close the aperture, the transition including a buckling of the actuating element, and
electrodes positioned to apply the voltage to the actuating element;
a plurality of row address lines, each row address line corresponding to a row of valves; and,
a plurality of column address lines, each column address line corresponding to a column of valves.

19. The system as set forth in claim 18 wherein each actuating element maintains the second state in the absence of the applied voltage.
